(19) United States
(12) Patent Application Publication
(10) Pub. No.: US 2012/0016854 A1
(43) Pub. Date: Jan. 19, 2012

(54) FILE-SHARING SYSTEM AND METHOD FOR MANAGING FILES, AND PROGRAM

(75) Inventors: Yoshiki Kano, Yokohama (JP); Naoki Utsunomiya, Machida (JP); Masaaki Iwasaki, Tachikawa (JP); Nobumitsu Takaoka, Sagamihara (JP); Takaki Nakamura, Ebina (JP); Yuichi Taguchi, Sagamihara (JP)

(73) Assignee: Hitachi, Ltd.

(21) Appl. No.: 12/738,936

(22) PCT Filed: Mar. 25, 2010
(86) PCT No.: PCT/JP10/02103

§ 371 Date: Apr. 20, 2010

(51) Int. Cl. G06F 17/30; G06F 15/16

(52) U.S. Cl. 707/704; 707/705; 707/E17.01; 707/E17.005

(57) ABSTRACT

A file, for which writing has been reserved, in a file-sharing system can be efficiently read. A check-in file agent is provided in a computer that executes check-in of a file as the file-write reserving processing, a file manager is provided in a file-sharing computer, and a check-out file agent is provided in a computer that executes check-out of a file as the file reading processing. Upon request for check-in of a file, the check-in file agent divides the file into divided files and generates metadata that indicates the order of division of the file, and transmits them to the file-sharing computer for storage therein. Upon request for check-out of the file, the check-out file agent receives the metadata from the file-sharing computer, and based on the metadata, sequentially receives the divided files to generate a file to be checked out.

### TECHNICAL FIELD

The present invention relates to a file-sharing system and a method for managing files, and a program. For example, the invention relates to processing performed when, during check-in processing of a file, a check-out request for the same file is issued.

### BACKGROUND ART

Using a file-sharing system allows a plurality of users to edit and update files from document management software or file version management software. Such a file-sharing system places a write lock on a file in order to prevent a plurality of users from simultaneously updating the same file (see FIG. 1), by executing file-write reserving processing which is called “check-in” processing in which information to the effect that file writing processing is to be executed is provided. When a file is checked in, read access to the file is prohibited, that is, the file is read-locked until the completion of the writing in order to prevent other users from acquiring incomplete information. Therefore, while a given user is checking in a file, other users cannot check out (i.e., read) the file.

In FIG. 1, a computer 121 at a center 120 has a file manager (File Mgr) and is configured to process check-in/check-out requests. A computer 101 or 111 at each site has a file agent that transfers files through check-in or check-out processing by communicating with the computer at the center. In FIG. 1, the computer 101 at a site A performs check-in processing, and the computer 111 at a site B performs check-out processing. Though not shown, each computer is loaded with an operating system (OS) that is operative to perform storage or management of files, execution of programs, and the like in order to execute the file agent or the file manager.

Such a conventional file-sharing system is based on the assumption that it is executed over a LAN with a band as wide as 100 Mbps, for example. Thus, the time in which other users must wait for a read-locked file while the file is checked in has not been a big problem except under special circumstances such as when the access is concentrated or when the file size is too large.

### Citation List

### Patent Literature

PTL 1: JP Patent Publication (Kokai) No. 7-28679 A (1995)

### SUMMARY OF INVENTION

### Technical Problem

However, when files are shared over a narrow-bandwidth network typified by the

Internet, the wait time for a user who requests for check-out of a file, in particular, has become longer. Such a problem will be described in more detail with reference to a sequence figure (FIG. 2) of the computer 101 at the site A and the computer 121 at the center. In a sequence 2001, the computer 101 at the site A transmits a check-in request to the computer 121 at the center. In a sequence 2002, the computer at the center, after generating a file to be stored therein and acquiring a read/write lock, acknowledges the receipt of the request by returning a response to the computer at the site A. In a sequence 2003, the computer at the site A transmits file data. In a sequence 2004 after the completion of the file transmission, the computer at the center releases the lock and informs the site A of the completion of the file transmission. Meanwhile, if the computer 111 at the site B requests for check-out (2005) while a lock is placed in sequence 2001 through sequence 2004, errors occur (2006) as the read/write lock has already been acquired, and thus the check-out processing cannot be performed. After sequence 2004, the read/write lock is released, upon which the relevant file becomes accessible through check-out processing (2007). As described above, a user who requests for check-out of a file must wait for a long time due to the other user's check-in processing of the same file.

Further, with regard to files that are shared with file-sharing systems, there have been an increasing number of files that are megabytes to gigabytes in size for use in CAD, CAM, large-scale source code, or virtual machines, in addition to conventional files that are several kilobytes in size for use in offices. With the increased size of the files, the wait time also tends to become longer. The present invention has been made in view of the foregoing circumstances, and provides a technique that allows files to be transferred in response to a check-out request for a file even when check-in processing of the same file, which would require a long transmission time, is being executed.

### Solution to Problem

According to the present invention, in order to solve the aforementioned problem, a target file to be checked in is divided into a plurality of divided files, and a server that requests for check-in of the target file is configured to transfer the plurality of divided files, together with metadata thereon, to a center. Then, the divided files are transferred to a server that requests for check-out of the file, based on the metadata.

That is, in the file-sharing system in accordance with the present invention, a first computer (a computer 101 at a site A), when executing file-write reserving processing (check-in processing), divides a target file to be transferred to the center into a plurality of divided files, and transmits the plurality of divided files to the center. A third computer (a computer 121 at the center) receives the plurality of divided files for storage therein. A second computer (a computer 111 at a site B), when executing file reading processing (check-out processing) of the target file during the execution of the file-write reserving processing, acquires available divided files from among the plurality of divided files, and combines the acquired divided files to generate the target file.

The first computer generates a plurality of pieces of metadata for identifying each of the plurality of divided files and appropriately combining the plurality of divided files, and transmits the plurality of pieces of metadata to the third computer at the center before transmitting the plurality of divided files. The second computer, before acquiring the divided files, acquires the plurality of pieces of metadata, and, based on the metadata, acquires corresponding divided files.

Further, the second computer, in executing the file reading processing of the target file, determines from which server (an acquisition target server) including the first computer (the server (the computer 101) at the site A) and the third computer (the computer 121 at the center) the plurality of divided files are to be acquired, and, based on the plurality of pieces of metadata, requests the acquisition target server to transmit the plurality of divided files. In this case, the second computer checks the line conditions of the network and determines, based on the check result, a server with the best line conditions to be the acquisition target server. The line conditions of the network can be checked using any one of the network response comparison processing, network hop count comparison processing, and load comparison processing for the computer at each server.

The file-sharing system may further include, separately from the third computer (the computer 121 at the center), an auxiliary central server (a computer 131 at a center B) for storing files. In such a case, the third computer (121) transmits copies of the plurality of divided files to the auxiliary central server. The second computer acquires the plurality of pieces of metadata from the third computer, but acquires divided files corresponding to the acquired plurality of pieces of metadata from the auxiliary central server.

The second computer, upon request for access to part of the target file from an application, identifies a divided file that is needed to be the access based on the metadata, and acquires the identified divided file from the third computer. At this time, the third computer, if the identified divided file has not been received yet from the first server, acquires the relevant divided file from the first computer and then transmits the acquired divided file to the second computer.

Further features of the present invention will become apparent from the following best mode for carrying out the invention and the accompanying drawings.

### Advantageous Effects of Invention

According to the present invention, files can be efficiently transferred in response to a check-out request for a file even when the file is being checked in.

### BRIEF DESCRIPTION OF DRAWINGS

FIG. 1 is a diagram showing the logical configuration of a conventional file-sharing system.

FIG. 2 is a diagram for describing the processing sequence of each computer of a conventional file-sharing system.

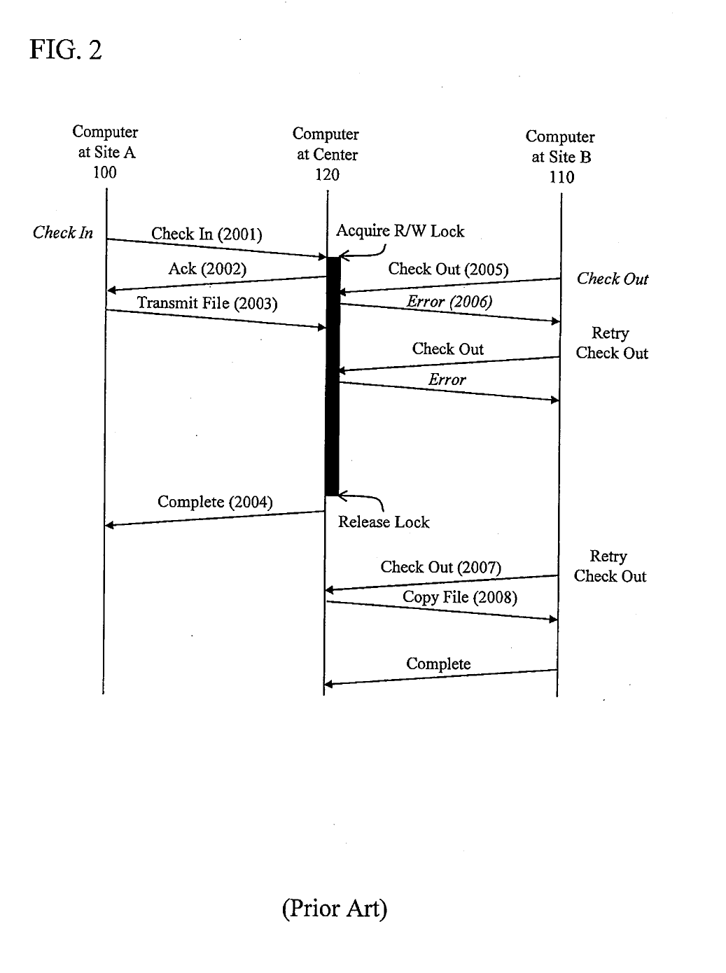

FIG. 3 is a diagram showing the physical configuration of a file-sharing system in accordance with the present invention.

FIG. 4 is a diagram showing the logical configuration of a file-sharing system in accordance with the first embodiment of the present invention.

FIG. 5 is a diagram showing the structure of directories in accordance with the present invention.

FIG. 6 is a diagram showing the structure of metadata in accordance with the present invention.

FIG. 7 is a diagram for describing the processing sequence of check-in/check-out processing performed between computers in accordance with the first embodiment.

FIG. 8 is a flowchart for describing the processing of generating divided files based on a check-in instruction issued by an operator 102 of a file agent 105 in accordance with the first embodiment.

FIG. 9 is a flowchart for describing the file transfer processing of the file agent 105 in executing check-in.

FIG. 10 is a flowchart for describing the processing performed by a file manager 126 of a computer 121 at a center upon receipt of a check-in request in accordance with the first embodiment.

FIG. 11 is a flowchart for describing the processing of checking out a file that is being checked in in accordance with the first embodiment.

FIG. 12 is a flowchart for describing the processing performed by the file manager 126 at the center upon receipt of a check-out instruction from a file agent 115 in accordance with the first embodiment.

FIG. 13 is a diagram showing the logical configuration of a file-sharing system in accordance with the second embodiment of the present invention.

FIG. 14 is a diagram for describing the processing sequence in accordance with the second embodiment.

FIG. 15 is a diagram showing a network management table in accordance with the second embodiment.

FIG. 16 is a flowchart for describing the processing of checking out a file that is being checked in in accordance with the second embodiment.

FIG. 17 is diagram showing the logical configuration of a file-sharing system in accordance with the third embodiment of the present invention.

FIG. 18 is a flowchart for describing the processing performed by the file manager of the computer 121 in response to a check-in request in accordance with the third embodiment.

FIG. 19 is diagram showing the logical configuration of a file-sharing system in accordance with the fourth embodiment of the present invention.

FIG. 20 is a sequence management table for each file in accordance with the fourth embodiment.

FIG. 21 is a flowchart for describing the check-out processing in accordance with the fourth embodiment.

FIG. 22 is a flowchart for describing the processing performed by the file agent 115 in response to an I/O (read/write) request in accordance with the fourth embodiment.

FIG. 23 is a flowchart for describing the processing performed by the file manager 126 at the center upon receipt of a file acquisition request in accordance with the fourth embodiment.

FIG. 24 is a flowchart for describing the processing performed by the file agent 105 on the check-in side upon receipt of a file acquisition request in accordance with the fourth embodiment.

FIG. 25 is a flowchart for describing the check-in processing of the file agent 105 in accordance with the fourth embodiment.

### DESCRIPTION OF EMBODIMENTS

Hereinafter, embodiments of the present invention will be described with reference to the accompanying drawings. It should be noted that this embodiment only illustrates examples for implementing the present invention and thus is not to be construed as limiting the technical scope of the present invention. Structures that are common throughout the drawings will be assigned the same reference numerals.

### Embodiment 1

(1) The First Embodiment

In order to archive check-out processing of a file that is being checked in, metadata is prepared for a target file to be checked in (divided files), and the divided files are transferred in accordance with the metadata during the check-out processing.

### <Physical Configuration of File-Sharing System>

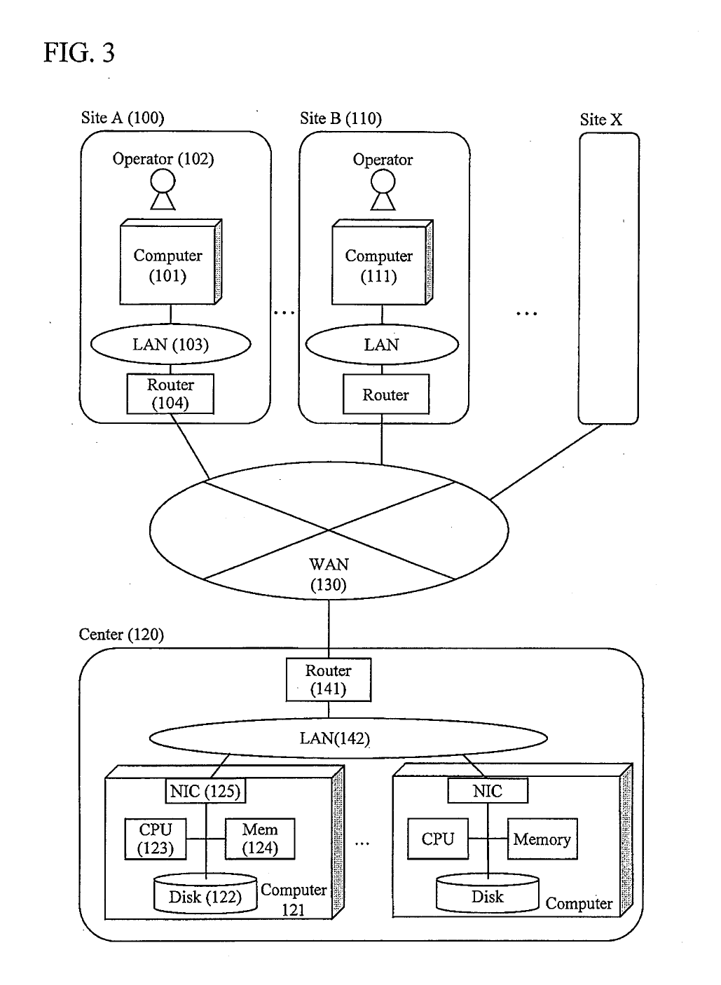

FIG. 3 is a diagram illustrating the schematic physical configuration of a file-sharing system in accordance with each embodiment of the present invention. The file-sharing system includes one or more centers 120 and one or more sites (a site A 100, a site B 110, . . . , and a site X). Each center and each site are connected via a wide area network (WAN) 130 typified by the Internet.

Each center includes a computer 121, a router 141, and a LAN (Local Area Network) 142. Examples of wide area networks include, but are not limited to, networks that can use protocols such as IP (Internet Protocol), ATM (Asynchronous Transfer Mode), Ethernet (Registered Trademark), and frame relay. The router connects the LAN to the wide area network to perform communication when communication with external computers is necessary. The router also performs, upon receiving a communication request from the wide area network, data transfer with the computer within the center. Examples of routers include, but are not limited to, those that can use protocols such as IP, ATM, and Ethernet (registered trademark).

The LAN has a function of establishing communication between the router and the computer. Examples of LANs include, but are not limited to, those that can use protocols such as IP, ATM, and Ethernet (registered trademark).

The computer 121 at the center 120 includes an MC (Network Interface Card) 125 that communicates with the LAN, a CPU (Central Processing Unit) 123, memory (Mem) 124, and a disk 122. It is assumed that the sizes of a router, a LAN, and a computer used at each site are substantially equal to or smaller than those at the center. Although the devices such as the router 104, the LAN 103, or the computer 101 may differ in size from those at the center, there are no functional differences between such devices. The computer also includes a keyboard that can be operated by an operator and a display. Accordingly, an operator can operate files through the computer.

### <Logical Configuration of File-Sharing System>

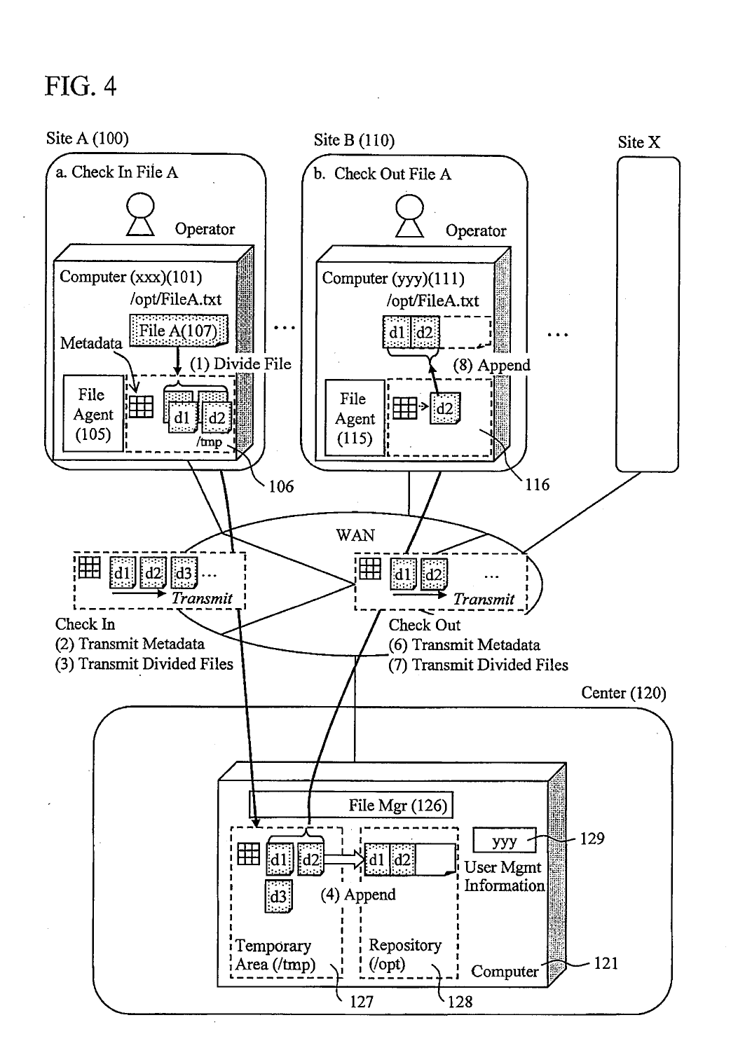

FIG. 4 is a diagram showing the logical configuration of a file-sharing system in accordance with the first embodiment of the present invention.

The computers 101 and 111 at the sites respectively have installed thereon file agents 105 and 115 that are configured to transmit and receive files in response to check-in and check-out requests. The computer 120 at the center has installed thereon a file manager (File Mgr) 126 that is configured to transmit and receive files in response to a check-in or check-out request and store the files in a repository 128 provided within the disk 122. Each computer has installed thereon an execution environment such as a typical operating system (OS) that operates to archive the file agent or the file manager. However, detailed description of such an operating system will be omitted as it is not directly related to the present invention.

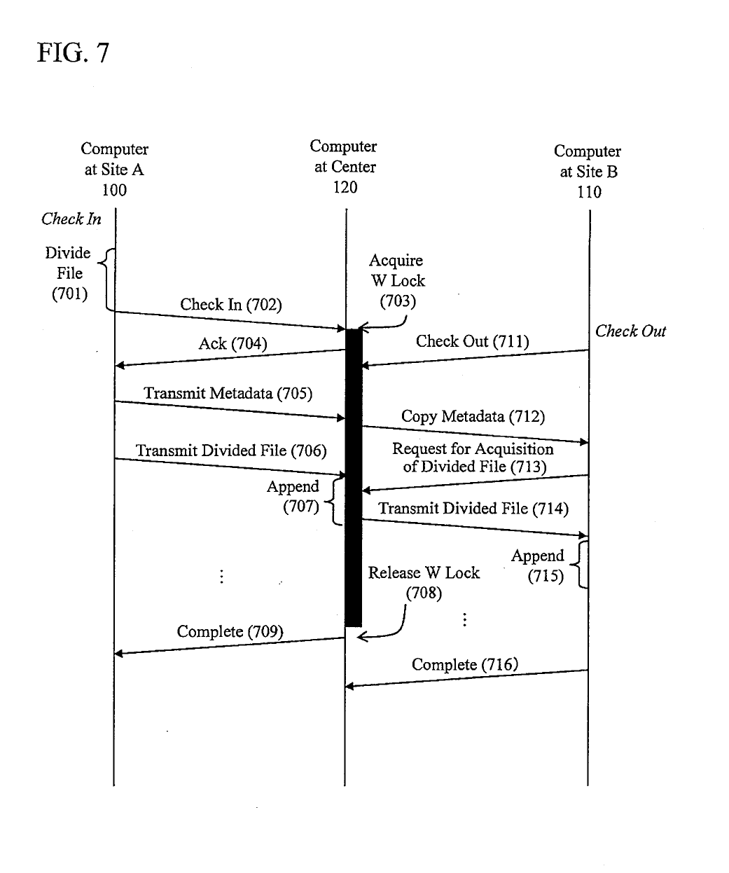

Each computer with the file agent installed thereon prepares a local file system, which is provided by the OS installed on the computer, and also prepares a temporary area (/tmp) 106 or 116 on the local file system to temporarily store divided files obtained from a file 107 for transfer of the files. The computer with the file manager installed thereon prepares a temporary area (/tmp) 127 for temporary storage of files and a repository 128 for long-term storage of files that are stored in execution of check-in processing, and also prepares user management information 129, based on which the presence/absence of access from (an)other computer(s) is determined. The overview of the check-in/check-out processing in accordance with this embodiment will be described with reference to a sequence figure of FIG. 7 and FIG. 4.

### <Directories of Files>

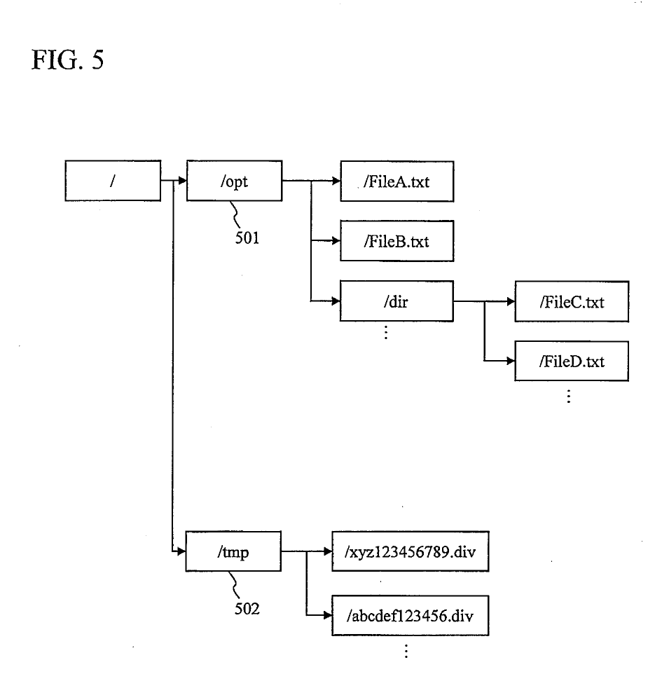

FIG. 5 is a diagram showing the structure of directories in accordance with the present invention. In the present invention, each computer has a directory hierarchy shown in FIG. 5. The way in which directories are used differs depending on the computer 101 or 111 at each site or the computer 121 at the center. Thus, the processing of each computer will be described hereinafter. In the computer 101, a file that has been stored by a user for check-in purposes is placed in a /opt directory 501. The file agent 105 divides the file and the resulting divided files are stored in a temporary area (Amp) 502. It should be noted that although /opt is used as a directory prepared for check-in purposes, other directory names can also be used.

The file manager 126 in the computer 121 receives the divided files transmitted from the computer 101 and stores them into the temporary area (/tmp) 127. Then, the file manager 126 combines the received divided files and stores them into the repository area (/opt) 128.

The file agent 115 in the computer 111 receives the divided files transmitted from the computer 121 and stores them into the temporary area (/tmp)116. Then, the file agent 115 combines the divided files and stores them as a file into a check-out directory area (in this embodiment, /opt).

### <Structure of Metadata>

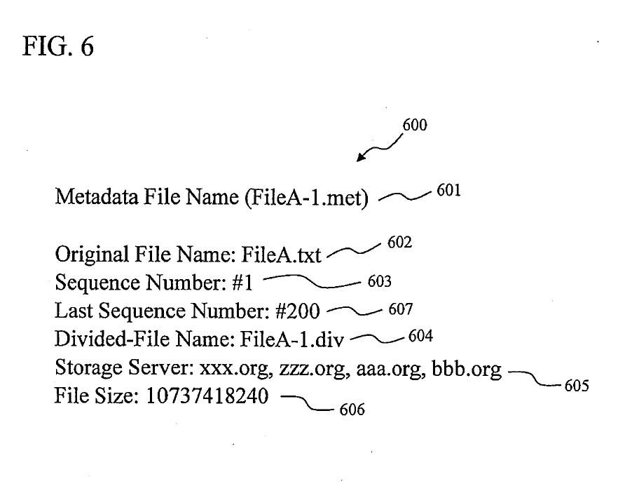

FIG. 6 is a diagram showing the structure of metadata in accordance with the present invention. Metadata 600 is data generated for, when the computer at the site A divides a file into a plurality of divided files with the file agent, each divided file, and is used to identify each divided file that has been generated and reproduce the original file by combining the divided files. The metadata 600 includes a metadata file name 601, original file name 602, sequence number 603 used in connecting files, last sequence number 607, and divided-file name 604. It should be noted that a storage server name 605 for storing data, and file size 606 are not used in this embodiment. Thus, detailed description thereof will be omitted.

For the metadata file name 601 of the metadata 600, a file name “met” is used as the extension of the divided-file name. The original file name 602 indicates the name of a file before divided. For the sequence number 603, the number of each divided file generated by the file agent 105 as described below is used. For the divided-file name 604, a file name composed of the file name and the sequence number is used. It should be noted that the metadata file name 601 and the divided-file name 604 shown herein are only examples of this embodiment. Thus, such names can be decided by different methods as long as they can help to identify the file transmission order and the files.

### <Sequence of the Check-in/Check-out Processing>

FIG. 7 is a diagram showing a sequence of the check-in/check-out processing performed between the computers in accordance with this embodiment. First, the sequence processing performed between the computer 101 at the site A and the computer 121 at the center when an operator of the site A checks in a file will be described.

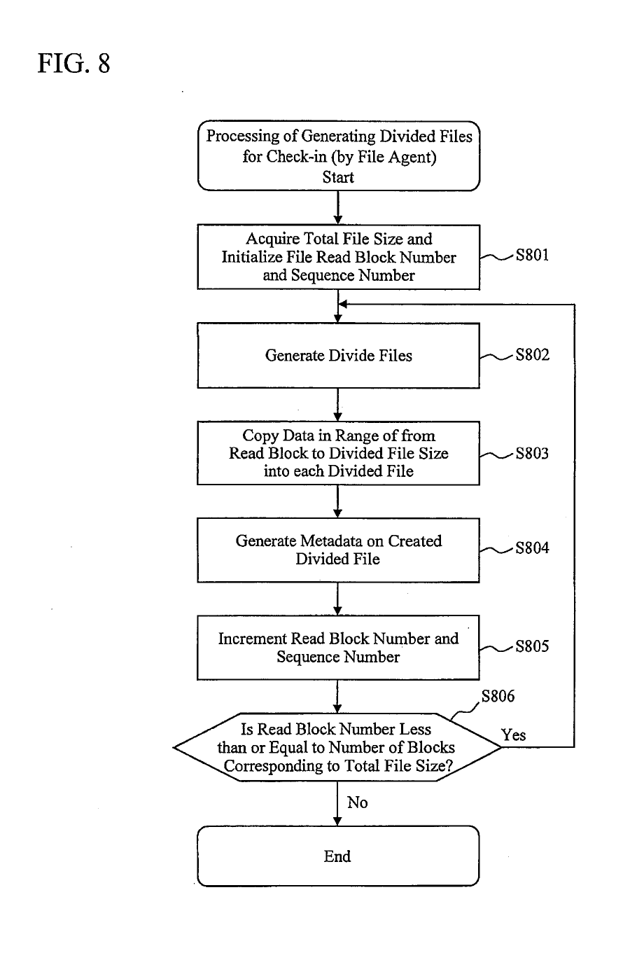

Sequence 701: The file agent 105 at the site A 100, based on a file stored in the check-in directory area (/opt), generates divided files and metadata thereon in the temporary area (/tmp) 106 (which corresponds to the processing (1) in FIG. 4). The details of the processing of generating the divided files and metadata thereon will be described below with reference to FIG. 8.

Sequence 702: The file agent 105 informs the file manager 126 at the center 120 of the check-in request together with the file name.

Sequence 703: The file manager 126 generates a target file to be checked in in the repository (/opt) 128. At this time, the file manager 126 acquires a write lock to prevent (an)other server(s) from simultaneously writing data to the file.

Sequence 704: The file manager 126 acknowledges (ACK) the receipt of the request by returning a response to the file agent 105 of the computer 101. Sequence 705: The file agent 105 at the site A sequentially reads metadata on the divided files to be transmitted, and transmits all of the metadata to the file manager 126 at the center 120 (which corresponds to the processing (2) in FIG. 4).

Sequence 706: The file agent 105 reads the divided files to be transmitted in the order of the sequence number, and transmits them to the file manager 126 at the center 120 (which corresponds to the processing (3) in FIG. 4).

Sequence 707: The file manager 126 stores the divided files that have been transmitted into the temporary area (/tmp) 127. Then, the file manager 126, upon completion of the reception of the divide files, checks the sequence number described in the metadata on each divided file, and appends the divided files to the file stored in the repository (/opt) 128 in accordance with the sequence numbers (which corresponds to the processing of (4) in FIG. 4).

Sequence 708: After sequences 706 and 707 are repeated, the file manager 126 checks from the last sequence number 607 of the metadata that all of the divided files have been transmitted, and then releases the write lock.

Sequence 709: The file manager 126 informs the file agent 105 at the site A of the completion of the file transmission.

Next, the sequence processing performed between the computer at the site B 110 and the computer 121 at the center when an operator of the site B 110 checks out the file (which is the target file to be checked in) via the computer 111 will be described.

Sequence 711: The file agent 115 of the computer 111 at the site B 110 informs the file manager 126 of the computer 121 at the center of the file name of the target file to be checked out.

Sequence 712: The file manager 126 transmits all metadata (metadata on all divided files) to the file agent 115 at the site B 110 (which corresponds to the processing (6) in FIG. 4).

Sequence 713: The file agent 115, based on the received metadata, requests for the divided files to the file manager 126 at the center 120.

Sequence 714: The file manager 126 at the center 120 transmits the divided files to the file agent 115 at the site B 110 (which corresponds to the processing (7) in FIG. 4).

Sequence 715: The file agent 115 stores the divided files that have been transmitted into the temporary area 116, and appends, upon completion of the transmission of the divided files, the divided files to the target file to be checked out (which corresponds to the processing (8) in FIG. 4). It should be noted that the file agent 115 generates a file at the time of the initial appending.

Sequence 716: The file agent 115 at the site B 110 repeats sequence 713 through sequence 715, and, upon checking from the last sequence number 607 of the metadata that all of the divided files have been acquired, informs the file manager at the center of the completion of the acquisition of the divided files.

The check-in and check-out sequence processing in accordance with this embodiment is as described above. Dividing a target file into a plurality of divided files and processing them as described above makes it possible to immediately transmit the divided files, which have just been transferred through the check-in processing, to a site that is requesting for check-out of the same target file. Thus, the wait time for a site that requests for check-out can be shortened to the minimum.

### <Processing of Generating Divided Files>

FIG. 8 is a flowchart for describing the processing of generating divided files based on a check-in instruction issued by an operator 102 of the file agent 105. This processing corresponds to the processing performed in sequence 701 of FIG. 7. Steps of the processing will be described below.

Step 801: The file agent 105 acquires the total size of the target file to be checked in (stored in /opt), and initializes the read block number (which corresponds to the current pointer) and the sequence number 603 that are used for generating divided files (sets the both values to #0, for example). In addition, the file agent 105 calculates the last sequence number 607 from the total file size and the size of each divided file (e.g., 64 MB) determined by the system.

Step 802: The file agent 105 generates divided files. At this time, the name determined with reference to FIG. 6 is used for the name of each divided file.

Step 803: The file agent 105 copies data on the target file to be checked in, in the range of from the read block to the divided file size, into each divided file.

Step 804: The file agent 105 generates metadata on each divided file. At this time, the sequence number 603 and the divided-file name 604, which have been previously determined, are used as they are. With regard to the last sequence number, a value obtained by dividing the file size 606 by the size of each divided file is used.

Step 805: The file agent 105 increments the read block number by the size of the divided file, and also increments the sequence number by one.

Step 806: If the file agent 105 determines that the read block number is less than or equal to the number of blocks corresponding to the total file size, the flow proceeds to step 802, and if the file agent 105 determines that the read block number is greater than the number of the blocks corresponding to the total file size, the flow ends.

The check-in processing of the file agent 105 is as described above.

### <File Transmission Processing in Executing Check-In>

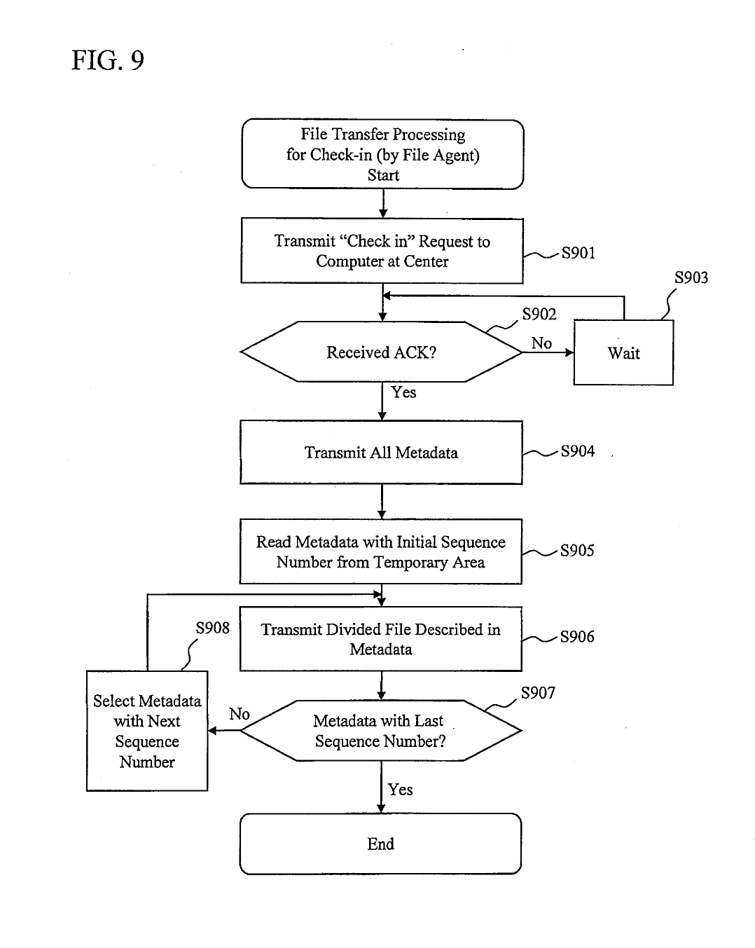

FIG. 9 is a flowchart for describing the details of the processing of transmitting files by the file agent 105 in executing check-in (which corresponds to the processing performed by the file agent in sequences 702 through 706 in FIG. 7). Steps of the processing will be described below.

Step 901: The file agent 105 transmits a check-in request for a target file together with the file name thereof to the file manager 126 of the computer 121 at the center 120.

Step 902: The file agent 105 checks if the file manager 126 has acknowledged

(ACK) the receipt of the request. If the answer to step 902 is Yes, the flow proceeds to step 904, and if the answer to step 902 is No, the flow proceeds to step 903.

Step 903: The file agent 105 stops the processing and waits for a predetermined period of time (for example several seconds).

Step 904: The file agent 105 transmits metadata on all divided files to the file manager 126 at the center 120.

Step 905: The file agent 105 reads metadata with the initial sequence number (e.g., the sequence number #0) from the temporary area (Amp) 106.

Step 906: The file agent 105 reads the divided-file name described in the read metadata, and transmits the corresponding divided file to the file manager 126 at the center 120.

Step 907: The file agent 105 checks if the acquired metadata is metadata with the last sequence number. If the answer to step 907 is Yes, the flow ends, and if the answer to step 907 is No, the flow proceeds to step 908.

Step 908: The file agent 105 selects metadata with the next sequence number, and reads it. Then, the file agent 105 transmits a divided file corresponding to the metadata to the center 120 in the same manner as that described above.

The processing of transmitting files by the file agent 105 in executing check-in is as described above.

<Processing Performed at the Center upon Receipt of a Check-In Request>

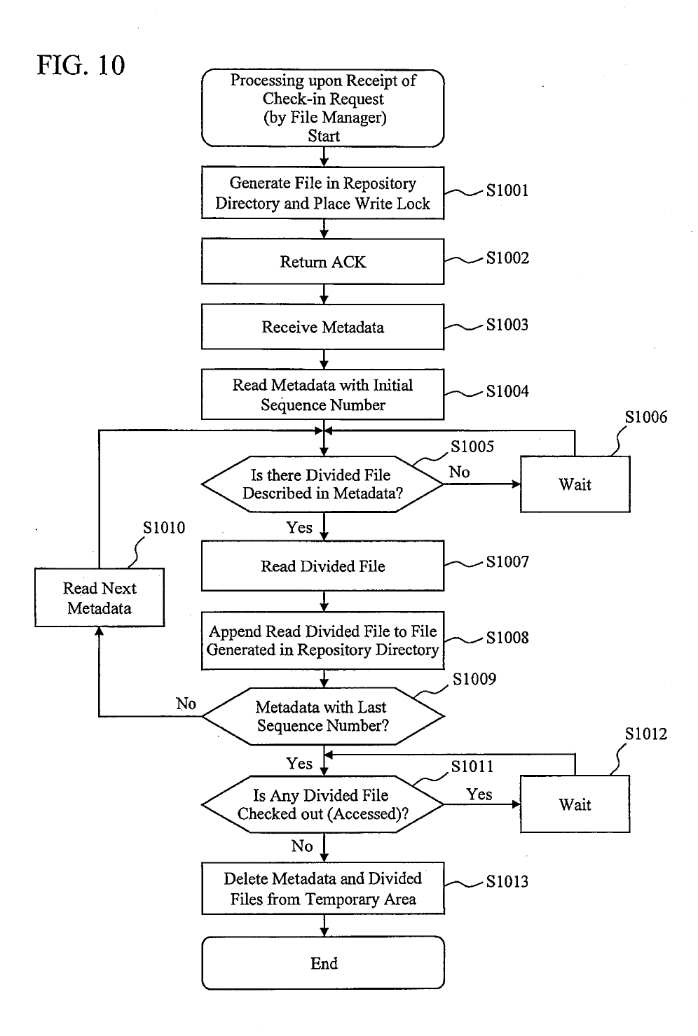

FIG. 10 is a flowchart for describing the processing performed by the file manager 126 of the computer 121 at the center 120 upon receipt of a check-in request in accordance with the resent invention (which corresponds to the processing performed by the file manager in sequences 702 through 706 in FIG. 7). Steps of the processing will be described below.

Step 1001: The file manager 126, upon receiving a check-in request, generates a file in the repository directory 128 based on the received file name. At this time, the file manager 126 also acquires a write lock on the same file.

Step 1002: The file manager 126 returns ACK, which indicates that the computer 121 is prepared to receive divided files, to the file agent 105 of the computer 101 at the site A 100.

Step 1003: The file manager 126 receives metadata on all divided files from the file agent 105 on the computer 101 at the site A 100, and stores it into the temporary area (/tmp) 127.

Step 1004: The file manager 126 reads metadata with the initial sequence number (e.g., #0) on the target file to be checked in.

Step 1005: The file manager 126 determines if a divided file corresponding to the divided-file name 604 described in the metadata resides in the temporary area 127. If the answer to step 1005 is Yes, the flow proceeds to step 1007, and if the answer to step 1005 is No, the flow proceeds to step 1006.

Step 1006: The file manager 126 stops the processing and waits for a predetermined period of time (several seconds).

Step 1007: The file manager 126 reads the divided file corresponding to the acquired metadata.

Step 1008: The file manager 126 appends the read divided file to the file generated in the repository 128.

Step 1009: The file manager 126 determines if the sequence number of the currently read metadata is the last sequence number 607 described in the metadata. If the answer to step 1009 is Yes, the flow proceeds to step 1011, and if the answer to step 1009 is No, the flow proceeds to step 1010.

Step 1010: The file manager 126 reads metadata with the next sequence number.

Step 1011: The file manager 126 refers to the user access information 129 to check for access to the divided file. If the answer to step 1011 is Yes, the flow proceeds to step 1012, and if the answer to step 1011 is No, the flow proceeds to step 1013.

Step 1012: The file manager 126 stops the processing and waits for a predetermined period of time (several seconds).

Step 1013: The file manager 126 deletes the non-accessed metadata (metadata that is not checked out) and the corresponding divided files from the temporary area (/tmp)127.

The processing performed by the file manager 126 upon receipt of a check-in request is as described above.

<Processing of Checking out a File that is Being Checked In>

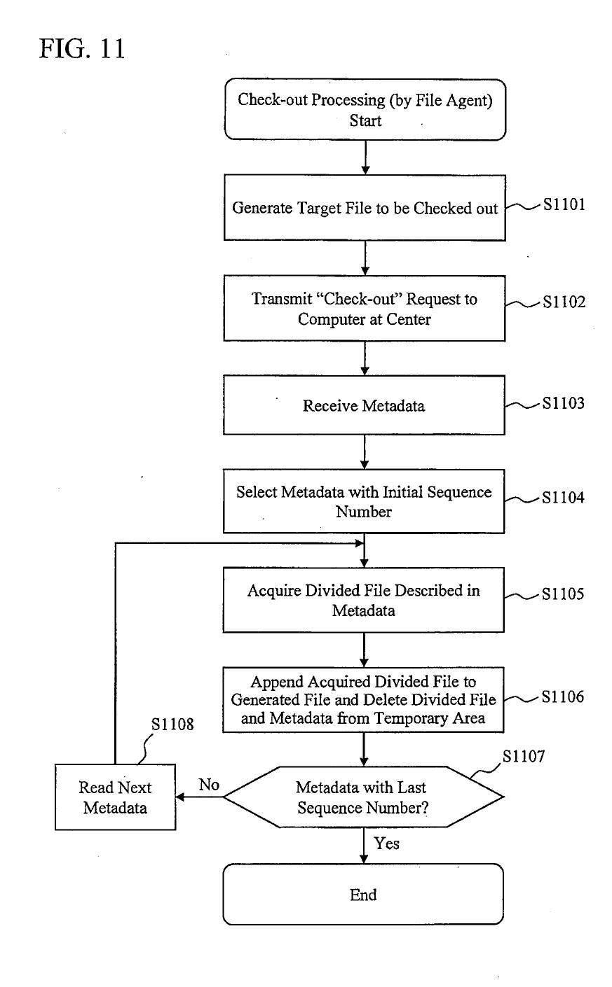

FIG. 11 is a flowchart for describing the processing in which an operator uses the file agent 115 at the site B 110 to check out a file which is being checked in from another site (the site A 100). Steps of the processing will be described below.

Step 1101: The file agent 115 generates a target file to be checked out in a check-out directory (/opt).

Step 1102: The file agent 115 transmits a check-out request together with a file name to the file manager 126 of the computer 121 at the center 120.

Step 1103: The file agent 115 receives metadata on all divided files from the file manager 126.

Step 1104: The file agent 115 selects a metadata file with the initial sequence number (in this embodiment, zero).

Step 1105: The file agent 115 acquires a divided file described in the selected metadata from the center 120.

Step 1106: The file agent 115 appends the divided file to the target file to be checked out, and deletes the appended divided file and the corresponding metadata file from the temporary area (/tmp) 116.

Step 1107: The file agent 115 checks for the presence of the next metadata file. If the answer to step S 1107 is Yes, the flow ends, and if the answer to step 1107 is No, the flow proceeds to step 1108.

Step 1108: The file agent 115 reads a metadata file with the next sequence number.

The processing of checking out a file, which is being checked in from a different site, by an operator via the file agent 115 is as described above.

<Processing Performed at the Center upon Receipt of a Check-Out Request>

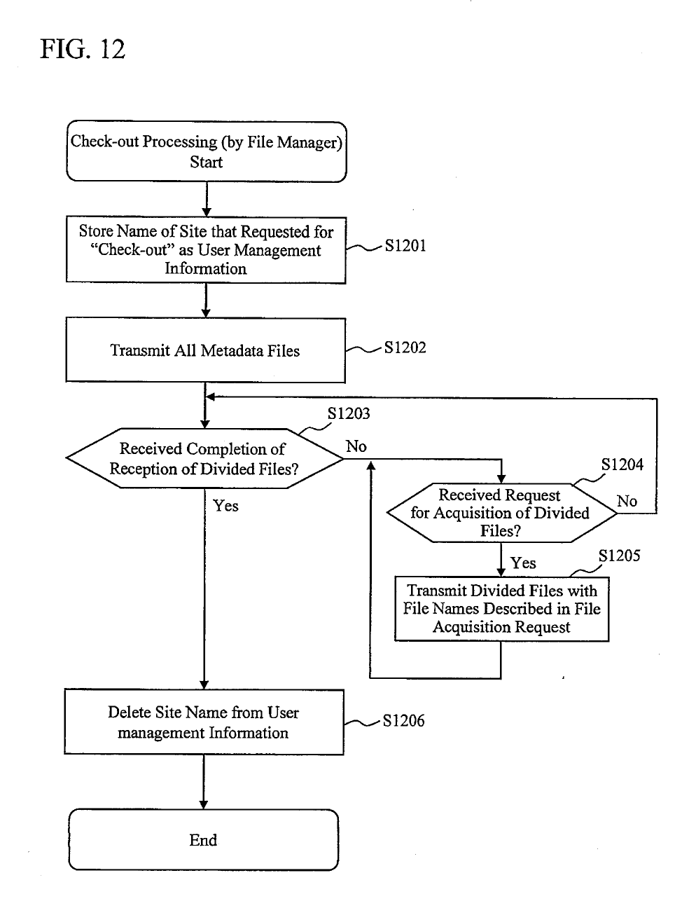

FIG. 12 is a flowchart for describing the processing performed by the file manager 126 at the center 120 upon receipt of a check-out request from the file agent 115. The processing will be described below.

Step 1201: The file manager 126 at the center 120 stores the server (computer) name as the user access information 129.

Step 1202: The file manager 126 transmits to the file agent 115 at the site B 110 all metadata files for the target file to be checked out.

Step 1203: The file manager 126 determines (checks) if it has received information from the file agent 115 at the site B 110 to the effect that the file agent 115 has received all divided files corresponding to the metadata files (if sequence 716 in FIG. 7 is completed). If the answer to step 1203 is Yes, the flow proceeds to step 1206, and if the answer to step 1203 is No, the flow proceeds to step 1204.

Step 1204: The file manager 126 determines if it has received a request for acquisition of the divided files. If the answer to step 1204 is Yes, the flow proceeds to step 1205, and if not, the flow proceeds to step 1203.

Step 1205: The file manager 126 transmits files (divided files) based on the file names described in the request for acquisition of the divided files.

Step 1206: As the site B 110 has received all divided files, the file manager 126 deletes the server (computer) name from the user management information.

The processing executed by the file manager 126 upon receipt of a check-out instruction from the file agent 115 is as described above.

### <Conclusion of the First Embodiment>

According to this embodiment, it is possible to check out (transmit) a file that is being checked in, whereby check-out time can be reduced than that of the conventional check-out processing that is performed after the check-in processing.

Further, in execution of the check-out processing, received data can be sequentially read as the received data can be sequentially used. Further, if an application is used that permits received data to be sequentially written, editing becomes also possible.

It should be noted that migration of the divided files from the temporary area 127 to the repository 128 to generate a combined (appended) file can be executed at any of the following timings: (i) collectively executed after the reception of all divided files, (ii) sequentially executed after the reception of each divided file, with each divided file being held in the temporary area 127 until the completion of the reception of all divided files, and (iii) sequentially executed after the reception of each divided file, with the divided files that have been combined (appended) and the metadata being sequentially deleted from the temporary area 127. In the case of (i) and (ii), if a check-out request is received after the generation of the combined file, the combined file is transmitted as the target file to be checked out to the source of the request. If a check-out request is received before the generation of the combined file, it is acceptable as long as the aforementioned processing of transferring divided files is executed as the metadata and all divided files reside in the temporary area 127. Meanwhile, in the case of (iii), if a check-out request is received after some, but not all, of the divided files have been combined, the files that have been combined in the repository 128 and metadata that remains in the temporary area 127 are transmitted together to the source of the request. Then, the computer at a site that is the source of the request (in this embodiment, the computer 111 at the site B 110) acquires the divided files based on the metadata.

As described above, according to the first embodiment, in execution of the check-in processing, a target file to be transferred is divided into a plurality of divided files, and metadata (identification data that can identify each divided file and includes data that allows the divided files to be appropriately combined later at the time of combining the divided files) corresponding to each divided file is produced. Transfer of each divided file is executed based on such metadata. Accordingly, it is possible to reduce the check-in wait time for a user who requests for check-out of a file on a file-sharing system that uses a wide area network (WAN).

In addition, as the temporary area for storing divided files and metadata is provided separately from the repository for storing combined files, management of files that are not yet combined and files that are combined can be carried out easily. Thus, it is possible to respond to check-out requests that occur at various timings.

### Embodiment 2

(2) Second Embodiment

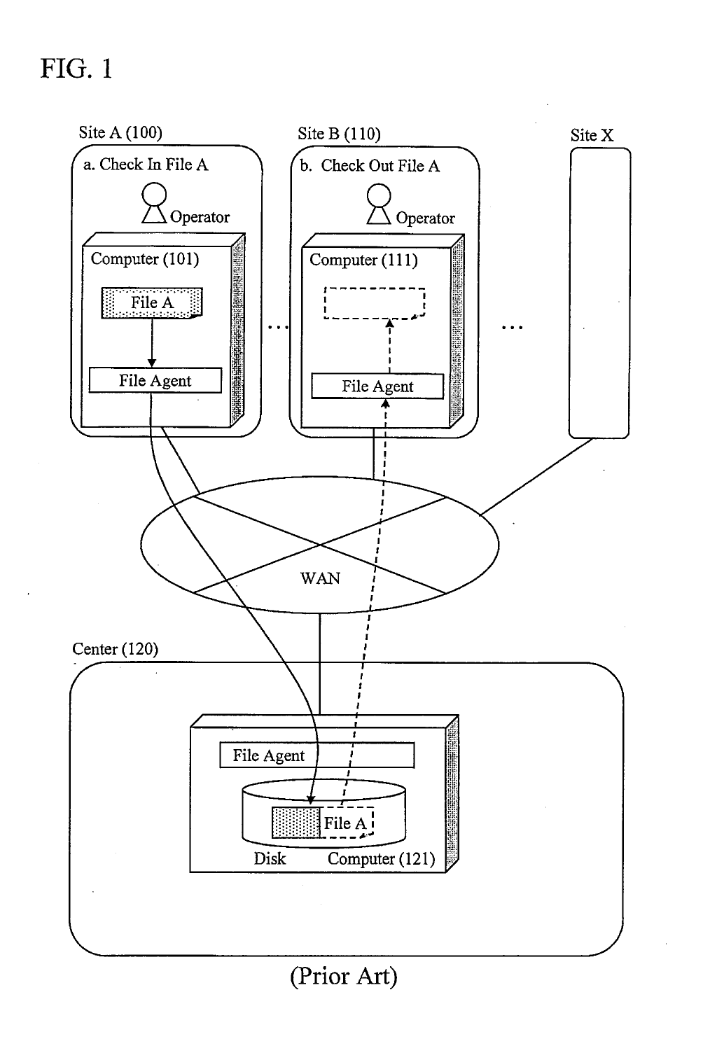

In the second embodiment, in the processing of checking out a file that is being checked in in accordance with the first embodiment, a network that is in the shortest network distance is searched for to execute file transfer, with a view to increasing the data transfer speed. Hereinafter, difference from the first embodiment will mainly be discussed. It should be noted that the physical configuration of this embodiment is similar to that of the first embodiment (FIG. 1). Hereinafter, changes made to some parts will be described. As used herein, the “network distance” means the number of routers (a command “trace route” is used) that exist between the center and the other sites, or the response time when ping (a program configured to transmit an ICMP packet and to request for a response from the transmission destination) is executed between the center and the other sites.

### <Logical Configuration of the File-Sharing System>

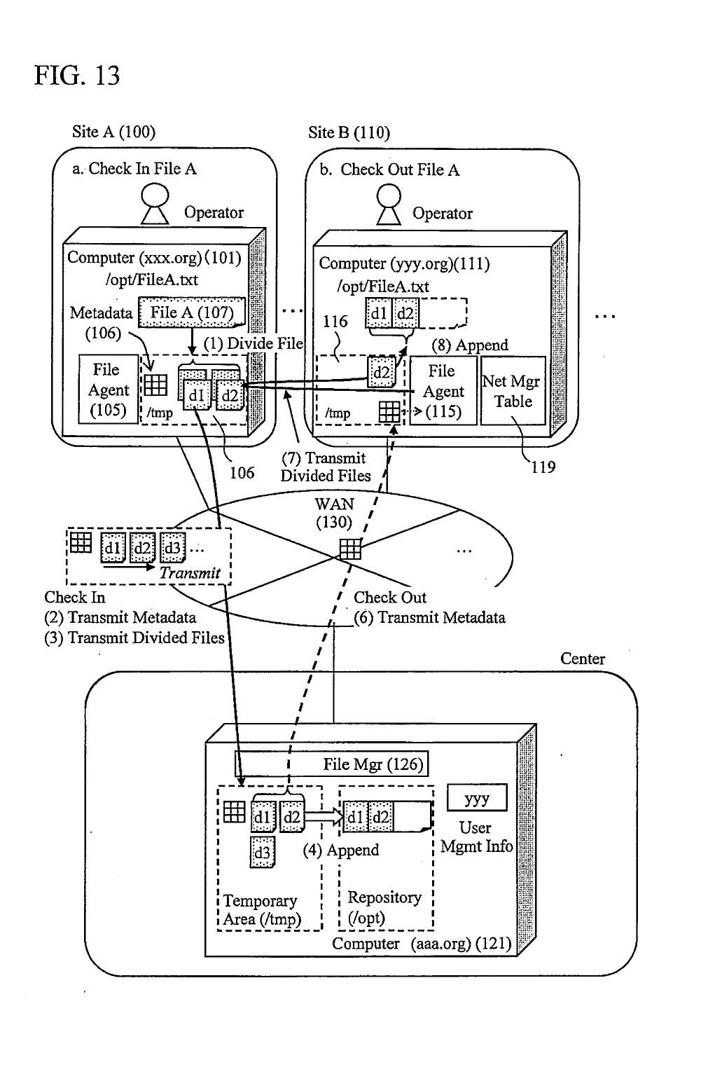

FIG. 13 is a diagram showing the logical configuration of a file-sharing system in accordance with the second embodiment of the present invention. The logical configuration of this file-sharing system differs from that of the first embodiment in that, when a check-out request from the operator of the site B 110 is processed, if it is determined that the response from the site A is faster than the response from the center 120, the file agent 115, instead of acquiring divided files from the center 120, selects the file agent 105 of the computer 101 with a faster response using a network management table (Net Mgr(Management) Table) 119, so that file transfer is executed.

Thus, the processing of the file agent 115 of the computer 111 and the file manager 126 at the center 120 of this embodiment differ from those of the previous embodiment. Further, the network management table 119 is added to the computer 111 at the site B 110.

### <Sequence of the Check-In/Check-Out Processing>

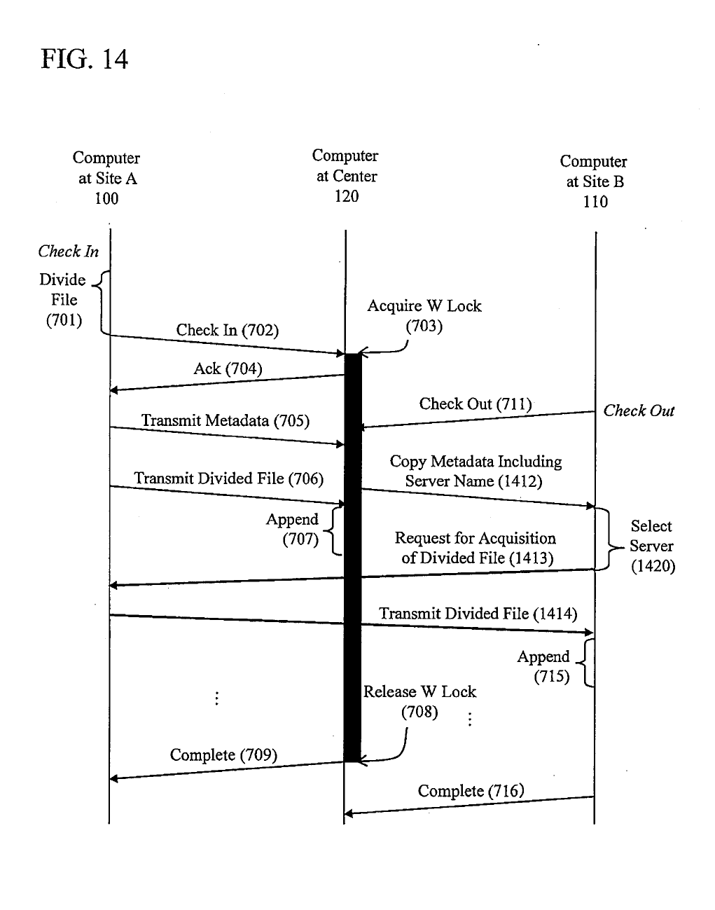

FIG. 14 is a diagram for describing the sequence of the check-in/check-out processing in accordance with the second embodiment. This sequence differs from that in FIG. 7 in that sequences 1412, 1420, 1413, and 1414 are needed instead of sequences 712, 713, and 714. Hereinafter, only the processing of each sequence that has been changed from FIG. 7 will be described. The processing of the other sequences is the same as that of the first embodiment.

Sequence 1412: The file manager 126 at the center 120 transmits all metadata to the file agent 115 at the site B 110. At this time, the file manager 126 stores, as the additional items of the metadata, the server name (e.g., xxx.org) of the computer 101 at the site A 100 and the server name (e.g., aaa.org) of the computer 121 at the center as the storage server name 605 in FIG. 6 (which corresponds to the processing of (6) in FIG. 13).

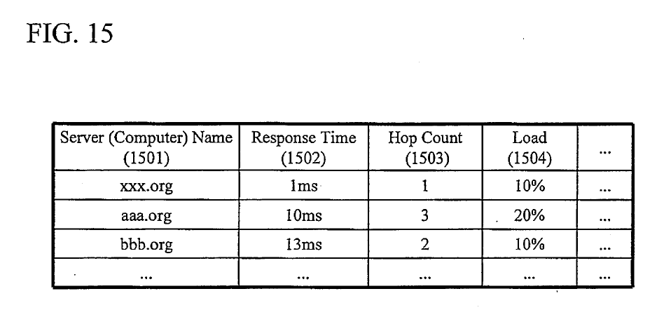

Sequence 1420: The file agent 115 at the site B 110, based on the item: storage server name 605 of the metadata, executes ping to each server to measure the network line conditions, and creates a network management table such as the one shown in FIG. 15 which includes a server (computer) name 1501 and the response time 1502 to select a server with the shortest response time. In this embodiment, the response time is measured using ping to measure the network line conditions. However, it is also possible to use a hop count 1503 of the network (select a server with a small hop count), load 1504 on the CPU of each computer (select a server with a small load), or the like. Alternatively, it is also possible to determine the priority for acquisition of divided files based on a value obtained by weighing the response time, hop count, and load (corresponding to the performance of a server to be selected) (placing the highest priority on the load).

Sequence 1413: The file agent 115 at the site B 110 creates an URL (e.g., http://xxx.org/tmp/File A-1.div) for enabling access to files in the server selected in sequence 1420, and requests for divided files to the file agent 105 on the computer 101 at the site A.

Sequence 1414: The file agent 105 transmits the divided files to the file agent 115 at the site B 110 via the WAN 130 (which corresponds to the processing (7) in FIG. 13).

It should be noted that if any site (server) that has already checked out the relevant file and holds it exists within a short network distance, other than the site A that is executing check-in or the center 120, the relevant file can be received from such site.

<Processing of Checking Out a File that is being Checked In>

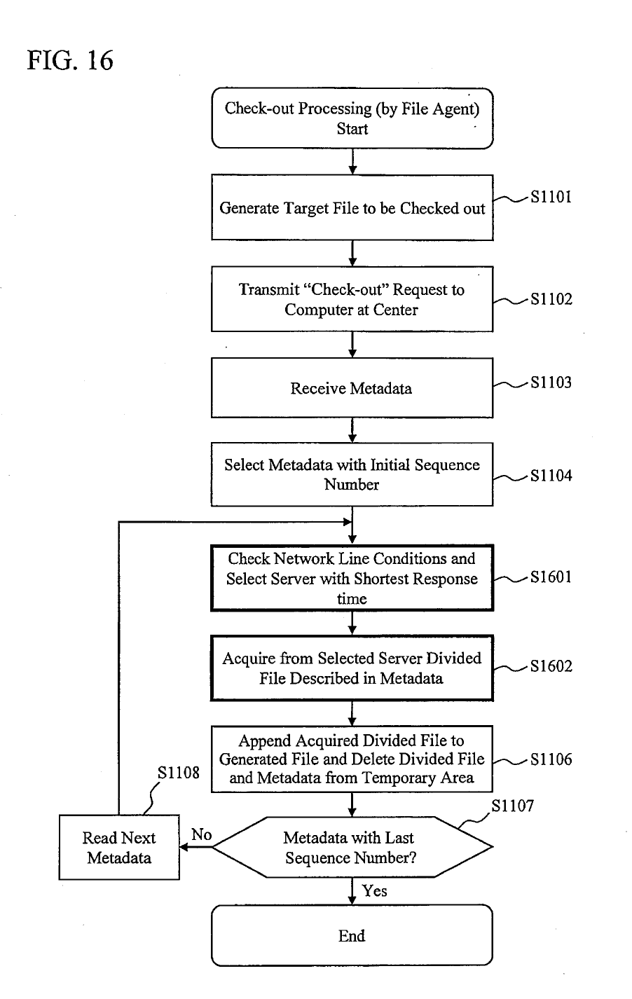

FIG. 16 is a flowchart for describing the processing of checking out a file that is being checked in in accordance with this embodiment. FIG. 16 differs from FIG. 11 in that step 1105 is replaced with steps 1601 and 1602. Only the steps that have been changed will be described below.

Step 1601: The file agent 115 at the site B 110 checks the network line conditions and selects a server (including the center 120) with the shortest response time. In this embodiment, an appropriate server is selected by checking which of the site 100 that is executing check-in and the center 120 is located within the shortest network distance (herein, the shortest response time). Such processing is the same as the processing performed in the aforementioned sequence 1420.

Step 1602: The file agent 115 at the site B 110 acquires from the server selected in step 1601 divided files described in the acquired metadata. Such processing is the same as the processing performed in the aforementioned sequence 1413.

The file agent 105 of the computer 101 at the site A 100 performs, in addition to the functions described in the first embodiment, transmission of divided files in response to a file request (http) from the file manager 126 of the computer 121 at the center 120. In this case, the file agent 115 at the site B 110 requests for access to the divided files stored in the temporary area 106 at the site A 100. In this embodiment, authentication is not executed upon request for files by the file agent 115. However, authentication with https(Hypertext Transfer Protocol over Secure Socket Layer), SSL, (Secure Socket Layer) and the like can be performed for security purposes.

It should be noted that the check-in processing performed by the file agent 105 at the site A 100 and the processing performed by the file manager 126 at the center 120 upon receipt of check-in and check-out requests are the same as the processing described in the first embodiment. However, in the second embodiment, step 1203 to step 1206, in which divided files are transmitted, of the processing in FIG. 12 are not executed, but instead, only metadata is transferred.

### <Conclusion of the Second Embodiment>

According to this embodiment, it is possible to achieve, in addition to the advantageous effects of the first embodiment, data transfer from an appropriate computer in accordance with the line conditions and to achieve a reduction in the network bandwidth on the center side by transferring data between the sites.

Further, in the file-sharing system, divided files are received from a server having the original checked-in data. Thus, it is also possible to reduce the network bandwidth of the wide area network used by the file-sharing system because the transfers among servers is distributed, not consolidated.

It should be noted that when check-out requests are issued in parallel from a plurality of sites at different moments in time, for example, computers at all of the sites need not acquire desired divided files from a single server. That is, such desired divided files can be acquired from a computer with the best line conditions which is selected from among a computer that requested for check-in (e.g., the computer at the site A), a computer at the center, and a computer at another site that is executing check-out (e.g., the computer at the site X). Accordingly, load on each server can further be reduced.

### Embodiment 3

(3) Third Embodiment

The third embodiment has, in addition to or separately from the feature of the second embodiment, the following feature: copies of the divided files held on the computer 121 at the center 120 are transferred to and stored into another center (a center B 130), whereby load distribution of the performance of the center 120 is achieved and the transfer time in check-out is reduced. Hereinafter, difference from the second embodiment will mainly be discussed based on the assumption that the aforementioned feature is provided in addition to the feature of the second embodiment. It should be noted that the physical configuration of the file-sharing system is similar to that shown in FIG. 1.

### <Logical Configuration of the File-Sharing System>

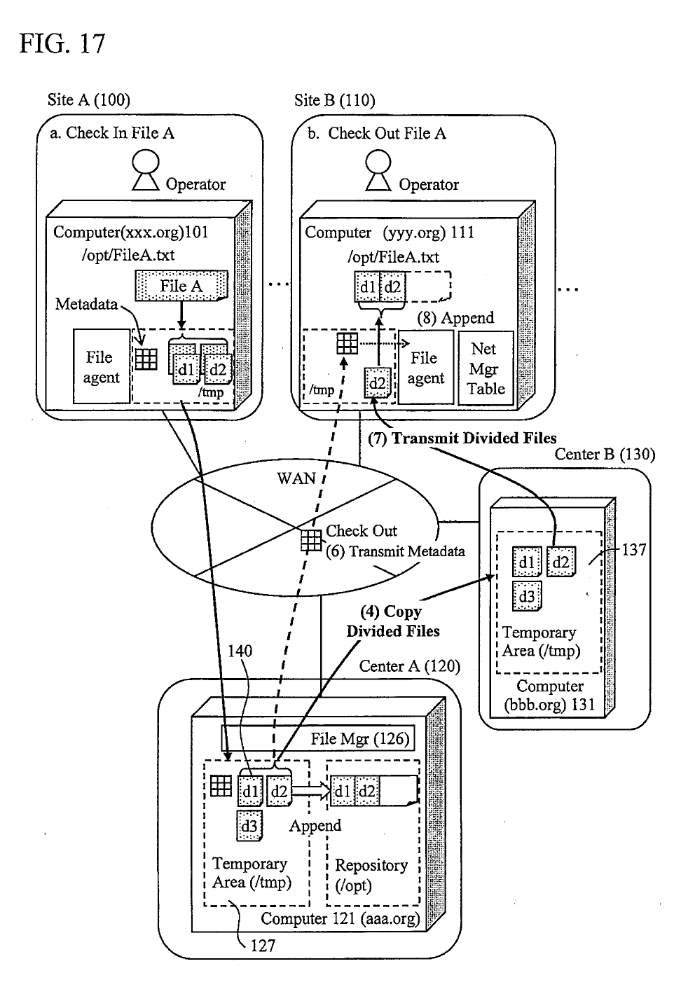

FIG. 17 is a diagram showing the logical configuration of a file-sharing system in accordance with the third embodiment of the present invention. FIG. 17 firstly differs from FIG. 13 in that a computer 131 at another center (a center B 130 in the drawing) that performs load distribution of the center A 120 is prepared. The computer 131 has about the same physical configuration as the computer 121 at the center A 120, and is connected to the center A 100 via a router and a LAN. A brief summary of the operation of the computer 131 is as follows: at the same time as the check-in processing performed by the computer 101 at the center A 100, divided files 140 stored in the temporary area 127 are transferred to and stored into a temporary area (/tmp) 137 by executing file transmission processing via a http protocol to the computer 131 at the center B 130. In addition, bbb.org (a server name representing the computer 131 at the center B 130) is added as a new server for the served server name in the metadata. The computer 111 at the site B 110 that has received the metadata with the extension checks the network conditions (e.g., checks the load on the network using a ping command) including the added computer 131, and then divided files are transferred.

Such processing can also be performed while switching the source, from which divided files are acquired, between the center A 120 and the center B 130.

<Processing performed at the Center A upon Receipt of a Check-In Request>

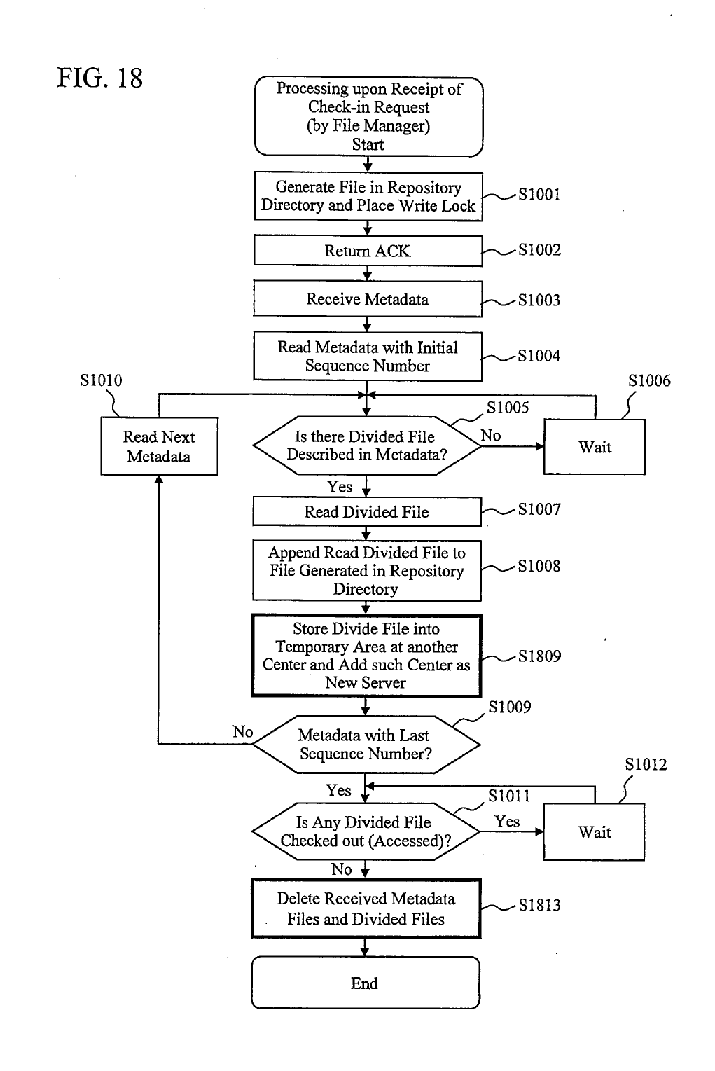

FIG. 18 is a flowchart for describing the processing performed by the file manager 126 of the computer 121 at the center A 120 upon receipt of a check-in request from the computer 101 at the site A 100 in accordance with the third embodiment of the present invention. FIG. 18 is basically based on FIG. 10. Thus, only the changed points will be described below.

Step 1809: The file manager 126 stores the divided files into the temporary area (/tmp) 137 of the computer 130 through the put processing with http. At this time, the file manager 126 adds a server name (e.g., bbb.org) of the computer (the computer 131 at the center B 130) in which the divided files have been newly stored, as the entry 605 of the served server (the storage server) in the metadata.

Step 1813: The file manager 126 deletes the received metadata files and divided files from the temporary area (/tmp) 127 of the computer 121 in the same manner as in FIG. 10, and also deletes the divide files (copies) from the temporary area (Amp) 137 of the computer 131 at the center B 130 (or the computer 131 deletes the copied divided files in response to a delete request from the file manager 126).

### <Conclusion of the Third Embodiment>

According to this embodiment, copies of the divided files held by the computer 121 at the center A 120 are stored into another center (the center B 130), whereby it becomes possible to achieve, in addition to the advantageous effects of the second embodiment, a further reduction in the transfer time in check-out. In addition, load for server and network on the center A 120 can be reduced.

It should be noted that even when a configuration such as the one described in the second embodiment is not used, it is still possible to alleviate the load on the network only by storing copies of the divided files, which are stored on the computer 121 at the center A 120, into another center (the center B 130), whereby the advantageous effect that the transfer time in check-out can be reduced is expected to be achieved.

### Embodiment 4

(4) Fourth Embodiment

According to the fourth embodiment, when an application in a host (e.g., the computer 111 at the site B 110) executing check-out processing has accessed a given address of a target file, a divided file that includes the accessed address is preferentially transferred. Hereinafter, difference from the first embodiment will mainly be discussed. It should be noted that the physical configuration of the file-sharing system of this embodiment is similar to that in FIG. 1.

### <Logical Configuration of File-Sharing System>

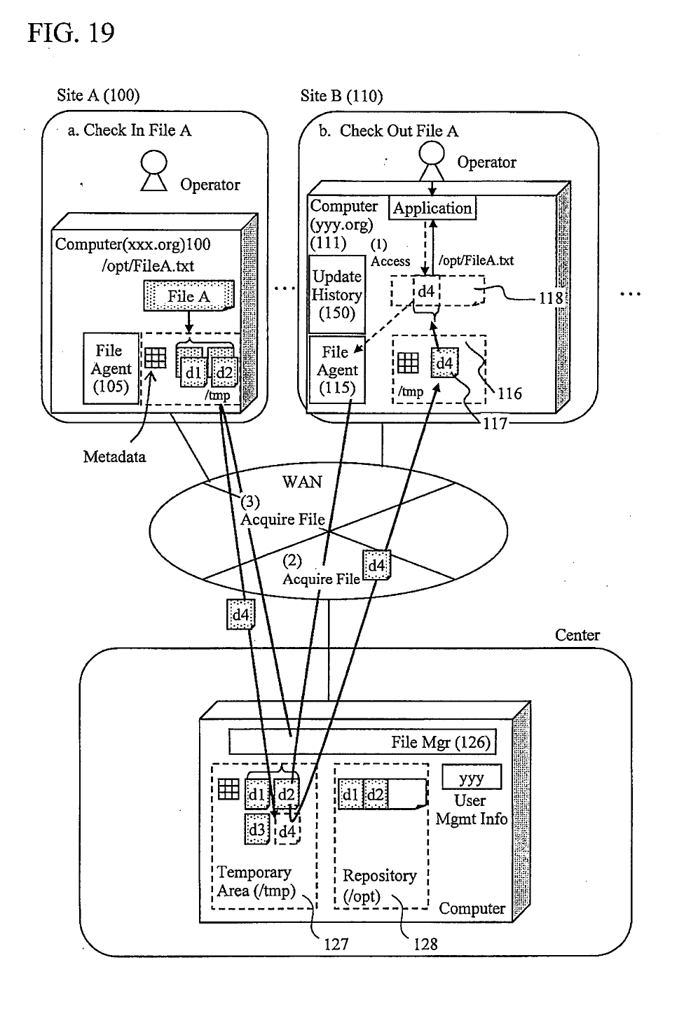

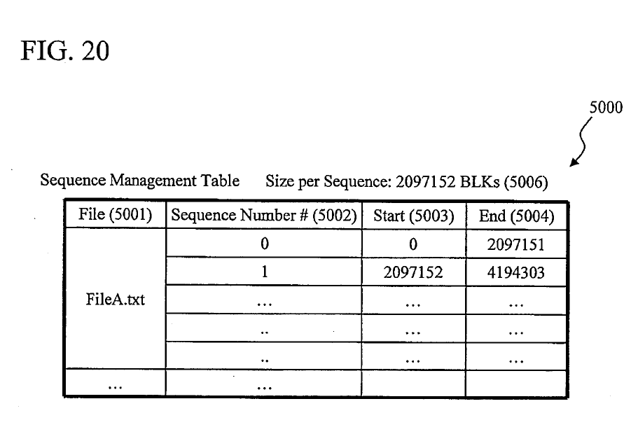

FIG. 19 is a diagram showing the logical configuration of a file-sharing system in accordance with the fourth embodiment of the present invention. The configuration of FIG. 19 is basically the same as that in FIG. 4 but differs in that an application executes access to a desired file; an update history table 150 for managing an updated file area is further provided; and, though not shown in FIG. 19, a file sequence management table 5000 (see FIG. 20) for each file is further provided.

A brief summary of the operation of this configuration is as follows: the computer 111 at the site B 110 generates in advance a file 118 that is an empty file (which will be filled with data each time a divided file is acquired), and the file agent 115 monitors access from the application. When the file is accessed, if necessary data (divided files) have not been read in yet and are not stored in the temporary area (/tmp) 116 either, the file agent 115 acquires new files from the computer 121 at the center 120. For example, when a request to access divided files d1, d2, . . . is issued, if the temporary area 116 does not contain such files, the file agent 115 acquires such divided files from the center 120 using a GET command.

It should be noted that the entire complete file is not visible to an operator who uses the application as the application accesses only part of the file. If an application that requires part of a file to be read or written is used, such a request can be met.

### <File Sequence Management Table>

FIG. 20 is a diagram showing a sequence management table for each file in accordance with the fourth embodiment of the present invention. This management table is stored in memory of the computer 111 and includes as an entry a file name (File) 5001, sequence number (Seq#) 5002, start address BLK(Start) 5003 and end address BLK(End) 5004 of each sequence number, and size 5006 per sequence. This table is generated when the initial metadata is read as described below.

<Processing of Checking out a File that is being Checked In>

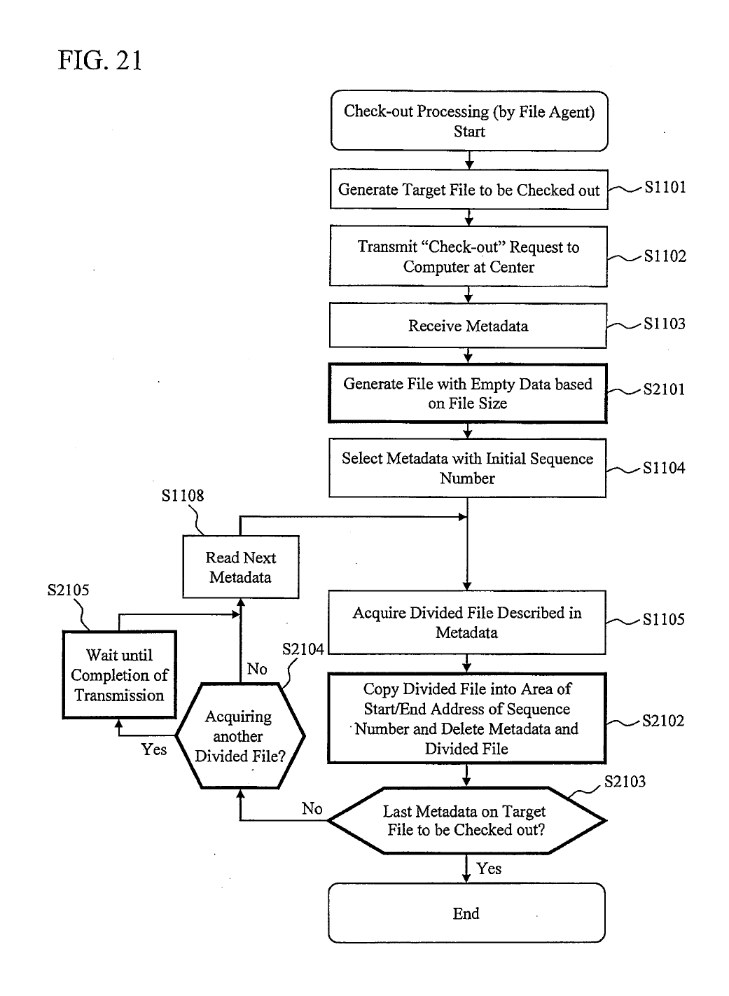

FIG. 21 is a flowchart for describing the processing of checking out a file that is being checked in in accordance with the fourth embodiment of the present invention. The basic processing of the flowchart is the same as that in FIG. 11. However, the flowchart in FIG. 21 includes, in order to acquire a divided file with a sequence number that is included in an I/O (read/write) access request described below, an additional step of checking if, after the normal reception of a divided file, processing of receiving another divided file is being executed, whereby transmission of a file through I/O access described below is executed. Hereinafter, the additional steps will be described.

Step 2101: The file agent 115 generates the file 118 with stored therein “null” data based on the file size of the metadata. Although “null” is used herein as dummy data for the file until divided files acquired are stored therein, other values like zero, other sequential number based on pre-number and so on can also be used.

Step 2102: The file agent 115 copies data on the received divided file into an area determined by the start address BLK 5003 and the end address 5004 of the sequence number in the file-sequence table 5000, within an area of the generated file 118. Then, the file agent 115 deletes the copied divided file and the corresponding metadata from the temporary area 116.

Step 2103: The file agent 115 checks if the currently processed metadata on the target file to be checked out is the last metadata, that is, the file agent 115 checks for the presence of the next metadata file. If the answer to step 2103 is Yes, the flow ends, and if the answer to step 2103 is No, the flow proceeds to step 2104.

Step 2104: The file agent 115 checks if another divided file is being acquired through I/O processing (if “Get file” is executed for another divided file). If the answer to step 2104 is Yes, the flow proceeds to step 2105, and if the answer to step 2104 is No, the flow proceeds to step 1108. Determination of if another divided file is being transmitted can be conducted by checking if step 2205 or step 2206 is being executed.

Step 2105: The file agent 115 enters a standby mode until the completion of the current file transmission. Execution of the present processing takes precedence over the transmission of the next file.

<Processing of I/O Request from the Application>

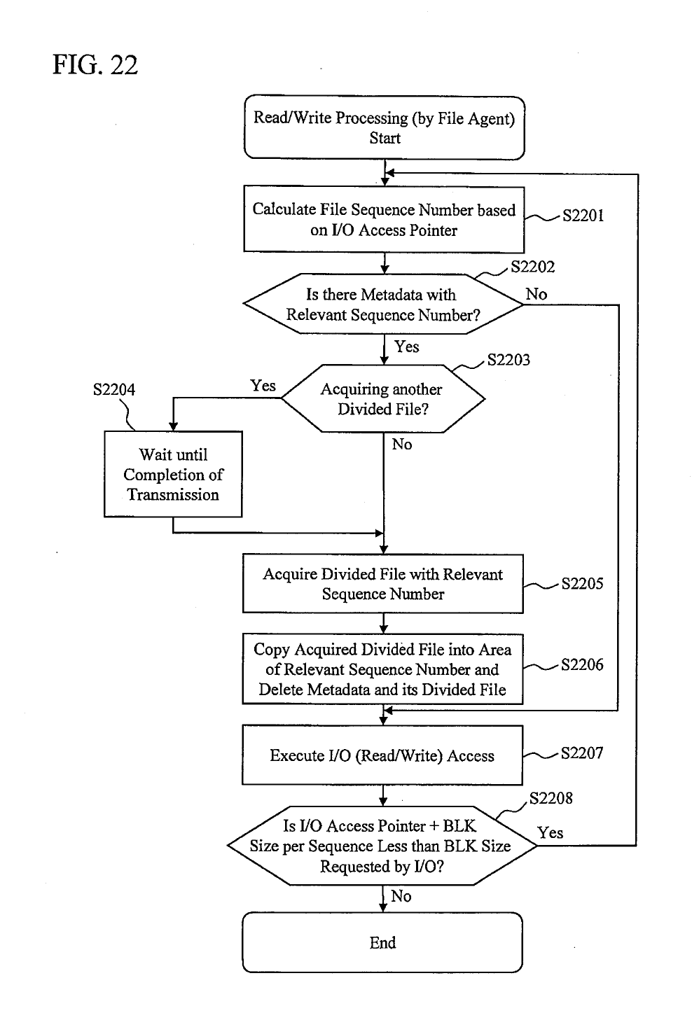

FIG. 22 is a flowchart for describing the operation of the file agent 115 in processing an I/O (read/write) request from the application in accordance with this embodiment. The file agent 115 at the site B 110 monitors a file I/O request from the application, and performs, if there has been a request for access to an area of the sequence number, I/O access to the file after reading the file. Such processing will be described below.

Step 2201: The file agent 115 calculates the sequence number of the file from the access pointer of the file in the I/O request (I/O access pointer). Such a sequence number is obtained from the quotient of (the BLK number of the file access pointer)/(the size 2006 per sequence).

Step 2202: The file agent 115 refers to a metadata file group in the temporary area 116 to check for the presence of a metadata file with the relevant sequence number. This is because, if the metadata is present, it means that the corresponding divided file has not been received yet, and if the metadata is absent within last sequence number 200, it means that the corresponding divided file has already been received. If the answer to step 2202 is Yes, the flow proceeds to step 2203 based on the assumption that the corresponding divided file has not been received yet, and if the answer to step 2202 is No, the flow proceeds to step 2207 based on the assumption that the corresponding divided file has already been received.

Step 2203: The file agent 115 checks if another divided file is being transmitted through different processing. If the answer to step 2203 is Yes, the flow proceeds to step 2204, and if the answer to step 2203 is No, the flow proceeds to step 2205.

Step 2204: The file agent 115 waits until the completion of the transmission of the currently transmitted file. Execution of the present processing takes precedence over the transmission of the next file.

Step 2205: The file agent 115 reads metadata with the relevant sequence number, and acquires the corresponding divided file from the computer 121 at the center 120.

Step 2206: The file agent 115 copies data on the received divided file into an area determined by the start address BLK 5003 and the end address 5004 of the sequence number in the file-sequence table 5000, within an area of the file 118. Then, the file agent 115 deletes the copied divided file and the corresponding metadata from the temporary area 116.

Step 2207: The file agent 115 accesses the relevant area in response to an I/O request (for read/write processing).

Step 2208: The file agent 115 checks if the sum of the current I/O access pointer and the BLK size per sequence is less than the BLK size requested by the I/O. If the answer to step 2208 is Yes, the flow proceeds to step 2201, and if the answer to step 2208 is No, the flow ends. This is because the desired data of a file may reside across a plurality of divided files in some cases. In such cases, processing for acquiring further necessary divided files is executed.

<Processing Performed at the Center upon Receipt of a File Acquisition Request>

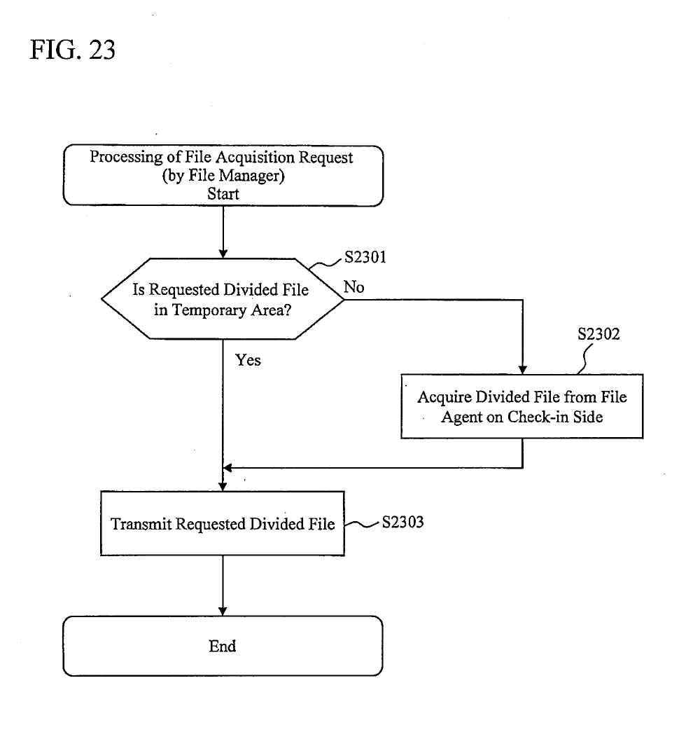

FIG. 23 is a flowchart for describing the processing performed by the file manager 126 at the center 120 upon receipt of a file acquisition request in accordance with this embodiment. Procedures of the processing will be described below.

Step 2301: The file manager 126 checks if a requested divided file is stored in the temporary area 127. If the answer to step 2301 is Yes, the flow proceeds to step 2303, and if the answer to step 2301 is No, the flow proceeds to step 2302.

Step 2302: The file manager 126 acquires the requested divided file from a file agent (e.g., the file agent 105) that is executing check-in (GET processing). Such processing corresponds to sequence (3) in FIG. 19.

Step 2303: The file manager 126 transmits the requested divided file to a file agent (e.g., the file agent 115) that is the source of the request.

<Processing Performed at the Site on the Check-In Side upon Receipt of a File Acquisition Request>

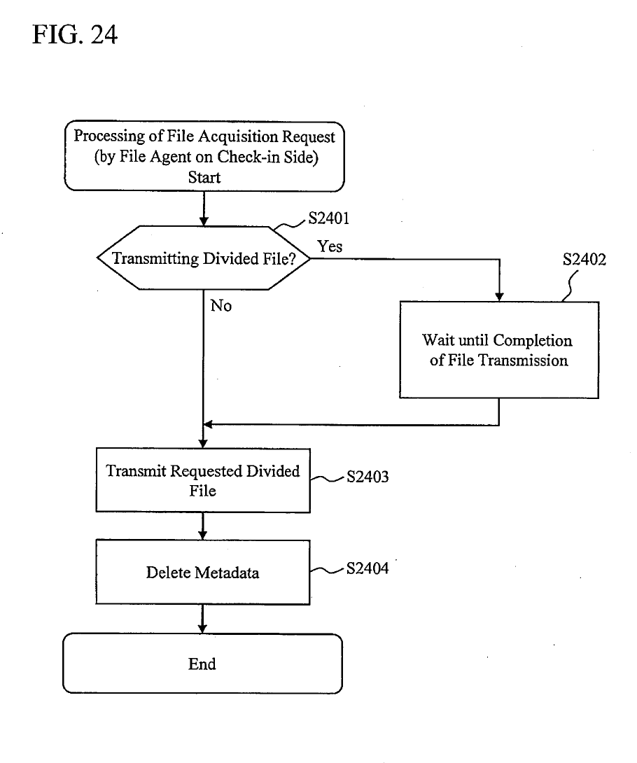

FIG. 24 is a flowchart for describing the processing performed by the file agent 105 on the check-in side upon receipt of a file acquisition request in accordance with the present invention. Procedures of the processing will be described below.

Step 2401: The file agent 105 checks if another divided file of a file, which is being checked in, is being transmitted. Determination of if another divided file is being transmitted can be conducted by checking if step 908 and step 906 are being executed. If the answer to step 2401 is Yes, the flow proceeds to step 2402, and if the answer to step 2401 is No, the flow proceeds to step 2403.

Step 2402: The file agent 105 enters a standby mode until the completion of the transmission of the currently transmitted another divided file. Execution of the present processing takes precedence over the transmission of the next file.

Step 2403: The file agent 105 transmits the requested divided file to the source of the request (herein, the center 120).

Step 2404: The file agent 105 deletes metadata on the transmitted divided file from the temporary area.

### <Check-In Processing by File Agent>

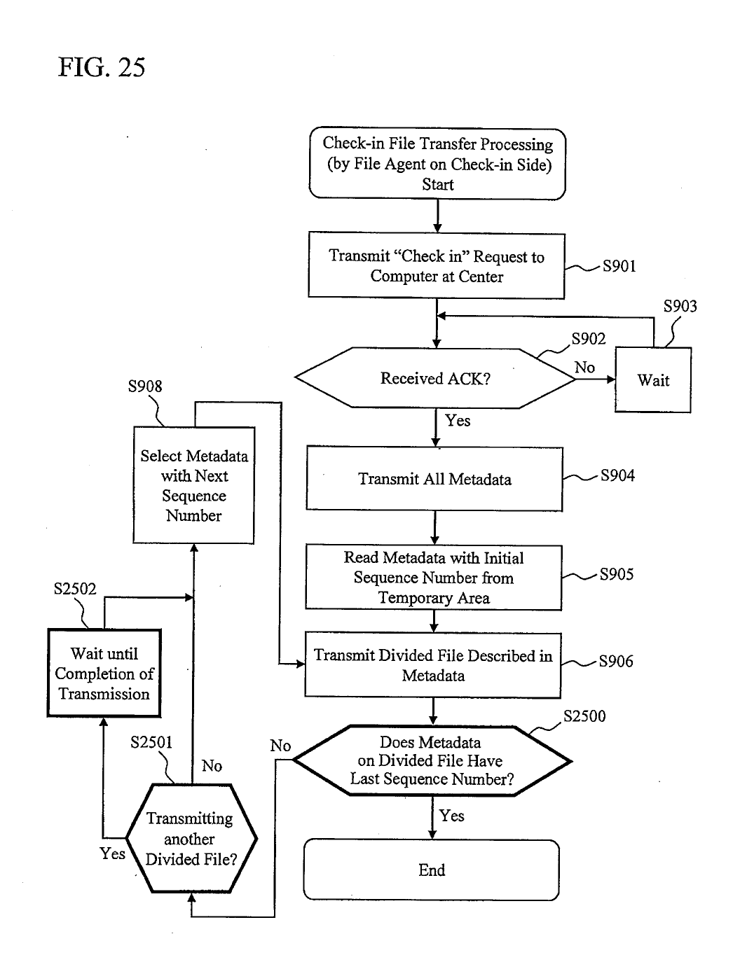

FIG. 25 is a flowchart for describing a file transfer operation executed through the check-in processing of the file agent 105 in accordance with this embodiment. The basic operation is the same as that in FIG. 9. However, processing for interrupting file transmission is added. Hereinafter, difference from the processing in FIG. 9 will be described.

Step 2500: After the transmission of the divided file corresponding to the metadata (step 906), the file agent 105 checks if the divided file is the data with the last sequence number. If the answer to step 2500 is Yes, the flow ends, and if the answer to step 2500 is No, the flow proceeds to step 2501.

Step 2501: The file agent 105 checks if another divided file, which is subjected to GET processing, is being transmitted. Determination of if another divided file is being transmitted can be conducted by checking if step 2403 and step 2404 are being executed. If the answer to step 2501 is Yes, the flow proceeds to step 2502, and if the answer to step 2501 is No, the flow proceeds to step 908.

Step 2502: The file agent 105 enters a standby mode until the completion of the current file transmission. Execution of the present processing takes precedence over the transmission of the next file.

### <Conclusion of the Fourth Embodiment>

In this embodiment, description has been made of a case in which the present access method is applied to the first embodiment. However, the present access method can also be applied to the second and third embodiments. In such cases, the processing of interrupting file transmission described in this embodiment needs to be performed in the check-in processing of the file agent 105 and the check-out processing of the file agent 115.

According to this embodiment, when an application in a computer that executes check-out requests for access to a given address of a file, a divided file that includes the accessed address can be preferentially transmitted, whereby check-out time seen by an operator can be reduced.

Further, in such a file-sharing system, it becomes possible to edit a file via an application even when the file is being transferred, by devising the transmission order of file data.

(5) Supplement

It should be noted that the present invention can also be realized by a program code of software that implements the function of the embodiments. In such a case, a storage medium having recorded thereon the program code is provided to a system or an apparatus, and a computer (or a CPU or a MPU) in the system or the apparatus reads the program code stored in the storage medium. In this case, the program code itself read from the storage medium implements the function of the aforementioned embodiments, and the program code itself and the storage medium having recorded thereon the program code constitute the present invention. As the storage medium for supplying such a program code, for example, a flexible disk, CD-ROM, DVD-ROM, a hard disk, an optical disc, a magneto-optical disc, a CD-R, a magnetic tape, a non-volatile memory card, ROM, or the like is used.

Further, based on an instruction of the program code, an OS (Operating System) running on the computer or the like may perform some or all of actual processes, and the function of the aforementioned embodiments may be implemented by those processes. Furthermore, after the program code read from the storage medium is written to the memory in the computer, the CPU or the like of the computer may, based on the instruction of the program code, perform some or all of the actual processes, and the function of the aforementioned embodiments may be implemented by those processes.

Moreover, the program code of the software that implements the function of the embodiments may be distributed via a network, and thereby stored in storage means such as the hard disk or the memory in the system or the apparatus, or the storage medium such as a CD-RW or the CD-R, and at the point of use, the computer (or the CPU or the MPU) in the system or the apparatus may read the program code stored in the storage means or the storage medium and execute the program code.

### Reference Signs List

100 Site A

101 Computer (Server) at Site A

102 Operator of Site A

103 LAN at Site A

104 Router at Site A

105 File agent

106 Temporary Area

107 File

110 Site B

111 Computer (Server) at Site B

115 File Agent

116 Temporary Area

120 Center

121 Computer at Center (Central Server)

122 Disk

123 CPU

124 Memory

125 NIC

141 Router

142 LAN

1501 Computer Name

1502 Response Time

1503 Hop Count

1504 Load

5001 File name

5002 Sequence Number

5003 Start Block

5004 End Block

5006 Size per Sequence

1. A file-sharing system comprising:
a first server computer with a first computer (101);
a second server computer with a second computer (111); and
a central server computer with a third computer (121), wherein:
the first server computer, the second server computer, and the central server computer are connected via a network,
the first computer (101), when executing file-write reserving processing, divides a target file to be transferred to the central server computer into a plurality of divided files, and transmits the plurality of divided files to the central server computer,
the third computer (121) receives the plurality of divided files for storage therein, and
the second computer (111), when executing file reading processing of the target file during the execution of the file-write reserving processing, acquires available divided files from among the plurality of divided files, and combines the acquired divided files to generate the target file.

2. The file-sharing system according to claim 1, wherein:
the first computer (101) generates the plurality of divided files and a plurality of pieces of metadata for identifying each of the plurality of divided files and appropriately combining the plurality of divided files, transmits a request to the third computer (121) to perform the file-write reserving processing, and, upon receiving an acknowledgment of receipt of the request from the third computer (121), collectively transmits the plurality of pieces of metadata and sequentially transmits the plurality of divided files to the third computer (121),
the third computer (121) places, upon receiving the request to perform the file-write reserving processing, a write lock on the target file, transmits, upon receiving a request to perform the file reading processing from the second computer (111) during the execution of the file-write reserving processing, the plurality of pieces of metadata to the second computer (111), transmits, in response to a request for acquisition of the divided files from the second computer (111) based on the metadata, the relevant divided files to the second computer (111), combines the plurality of divided files received from the first computer (101) at a predetermined timing to generate the target file, releases the write lock, and informs the first computer (101) of the completion of the file writing, and
the second computer (111) combines the plurality of divided files acquired from the third computer (121) to generate the target file, and informs the third computer (121) of the completion of the file reading processing.

3. The file-sharing system according to claim 1, wherein:
the first computer (101) generates a plurality of pieces of metadata for identifying each of the plurality of divided files and appropriately combining the plurality of divided files, and transmits the plurality of pieces of metadata to the third computer (121) before transmitting the plurality of divided files, and
the second computer (111) acquires the plurality of pieces of metadata before acquiring the divided files, and acquires, based on the metadata, corresponding divided files.

4. The file-sharing system according to claim 3, wherein:
the third computer (121) includes a temporary area for temporarily storing data and a repository area for storing a complete file, and the third computer (121) stores into the temporary area the received plurality of pieces of metadata and divided files, stores into the repository area a combined file that is obtained by combining the plurality of divided files based on the plurality of pieces of metadata, and finalizes the file-write reserving processing.

5. The file-sharing system according to claim 3, wherein the second computer (111) combines the acquired divided files, and deletes the divided files that have been combined and the corresponding metadata.

6. The file-sharing system according to claim 3, wherein the second computer (111), when executing the file reading processing of the target file, determines from which server computer (an acquisition target server computer) including the first server computer and the central server computer the plurality of divided files are to be acquired, and, based on the plurality of pieces of metadata, requests the acquisition target server computer to transmit the plurality of divided files.

7. The file-sharing system according to claim 6, wherein the second computer (111) checks line conditions of the network, and determines, based on a check result, a server computer with the best line conditions to be the acquisition target server computer.

8. The file-sharing system according to claim 7, wherein the second computer (111), in checking the line conditions of the network, uses one of network response comparison processing, network hop count comparison processing, and load comparison processing for the computer at each server computer.

9. The file-sharing system according to claim 3, further comprising, separately from the central server computer, an auxiliary central server computer (131) for storing files, wherein:
the third computer (121) of the central server computer transmits copies of the plurality of divided files to the auxiliary central server computer (131), and
the second computer (111) acquires the plurality of pieces of metadata from the central server computer, and acquires, based on the acquired plurality of pieces of metadata, the plurality of divided files that constitute the target file from the auxiliary central server computer (131).

10. The file-sharing system according to claim 3, wherein the second computer (111), upon request for access to part of the target file from an application, identifies a divided file that is needed to be the access based on the metadata, and acquires the identified divided file from the central server computer.

11. The file-sharing system according to claim 10, wherein the third computer (121), if the identified divided file has not been received yet from the first server computer, requests the first computer (101) to transmit the divided file, and transmits, after having received the divided file, the divided file to the second computer (111).

12. A method for managing files with a file-sharing system, the file-sharing system comprising a first server computer with a first computer (101), a second server computer with a second computer (111), and a central server computer with a third computer (121), all of the first server computer, the second server computer, and the central server computer being connected via a network, the method comprising:
causing the first computer (101) to, when executing file-write reserving processing, divide a target file to be transferred to the central server computer into a plurality of divided files, and to sequentially transmit the plurality of divided files to the central server computer, causing the third computer (121) to receive the plurality of divided files for storage therein, and
causing the second computer (111) to, when executing file reading processing of the target file during the execution of the file-write reserving processing, acquire available divided files from among the plurality of divided files and to combine the acquired divided files to generate the target file.

13. The file managing method according to claim 12, wherein:
the first computer (101) generates the plurality of divided files and a plurality of pieces of metadata for identifying each of the plurality of divided files and appropriately combining the plurality of divided files, and then, transmits a request to the third computer (121) to perform the file-write reserving processing,
the third computer (121), in response to the request to perform the file-write reserving processing, returns an acknowledgment of receipt of the request to the first computer (101) and, in response to the request to perform the file-write reserving processing, places a write lock on the target file,
the first computer (101), upon receiving the acknowledgment of the receipt of the request, collectively transmits the plurality of pieces of metadata and sequentially transmits the plurality of divided files to the third computer (121),
the second computer (111), during the execution of the file-write reserving processing, transmits a request to the third computer (121) to perform the file reading processing,
the third computer (121), in response to the request to perform the file reading processing from the second computer (111), transmits the plurality of pieces of metadata to the second computer (111),
the second computer (111), based on the plurality of pieces of metadata, transmits a request for acquisition of divided files to the third computer (121),
the third computer (121), in response to the request for acquisition of the divided files, transmits the relevant divided files to the second computer (111),
the third computer (121) combines the plurality of divided files received from the first computer (101) at a predetermined timing to generate the target file, releases the write lock, and informs the first computer (101) of the completion of the file writing, and
the second computer (111) combines the plurality of divided files acquired from the third computer (121) to generate the target file, and informs the third computer (121) of the completion of the file reading processing.

14. A program for causing a plurality of computers to function as the first to third computers (101, 111, 121) of the file-sharing system according to claim 1.
